(19) United States
(12) Patent Application Publication
(10) Pub. No.: US 2011/0054707 A1
(43) Pub. Date: Mar. 3, 2011

(54) SYSTEM AND METHOD FOR CONTROLLING POWER USAGE

(75) Inventors: Brandon M. Batzler, Hartford, WI (US); Kenny J. Stair, North Prairie, WI (US); Sie T. Lim, Jefferson, WI (US)

(73) Assignee: Briggs & Stratton Corporation

(21) Appl. No.: 12/548,265

(22) Filed: Aug. 26, 2009

(51) Int. Cl. G06F 19/00

(52) U.S. Cl. 700/286

(57) ABSTRACT

A control system for a home generator includes circuitry configured to determine a first cost of electricity provided by an off-site provider, determine a second cost of electricity produced by the home generator, compare the first cost with the second cost, and provide the result of the comparison as an output.

### BACKGROUND

The present disclosure relates generally to the field of building electrical systems and more specifically to building generation systems including utility power sources and standby power sources. Standby power systems are generally configured to provide backup power to electrical loads having the highest priority in the event of a utility source failure. The cost of electricity provided by utility sources can vary by the day, hour, or minute depending on the cost of the fuel source and the amount of power being consumed.

### SUMMARY

One exemplary embodiment relates to a control system for a home generator. The control system includes circuitry configured to determine a first cost of electricity provided by an off-site provider, determine a second cost of electricity produced by the home generator, compare the first cost with the second cost, and provide the result of the comparison as an output.

Another exemplary embodiment relates to a method of controlling a home generator. The method includes determining a first cost of electricity provided by an off-site provider, determining a second cost of electricity produced on-site, comparing the first cost of electricity to the second cost of electricity, and using the result of the comparison to decide whether to operate the home generator to produce electricity instead of using the electricity provided by the off-site provider.

Another exemplary embodiment relates to a home electricity system. The home electricity system includes a circuit breaker panel coupled to a number of electrical loads, a transfer switch coupled to the circuit breaker panel, a power line coupled to the transfer switch and configured to provide electricity from a utility provider, an engine-generator-set coupled to the transfer switch, and a control system. The control system is configured to determine a first cost of electricity provided by the utility provider, determine a second cost of electricity produced on-site, and compare the first cost with the second cost and provide the result of the comparison as an output.

It is to be understood that both the foregoing general description and the following detailed description are exemplary and explanatory only, and are not restrictive of the invention as claimed.

### BRIEF DESCRIPTION OF THE FIGURES

These and other features, aspects, and advantages of the present invention will become apparent from the following description, appended claims, and the accompanying exemplary embodiments shown in the drawings, which are briefly described below.

FIG. 1 is a schematic diagram illustrating a building electrical system, according to an exemplary embodiment.

FIG. 2 is a more detailed diagram of the main transfer switch of FIG. 1, according to an exemplary embodiment.

FIG. 3 is a more detailed diagram of the distribution panel of FIG. 1, according to an exemplary embodiment.

FIG. 4 is a more detailed diagram of the secondary transfer switch of FIG. 1, according to an exemplary embodiment.

FIG. 5 is a more detailed diagram of the subpanel of FIG. 1, according to an exemplary embodiment.

FIG. 6 is a flow chart illustrating a method for selecting a power source for an electrical system, according to an exemplary embodiment.

FIG. 7 is a flow chart illustrating a method for selecting a power source for an electrical system, according to another exemplary embodiment.

FIG. 8 is a flow chart illustrating a method for selecting a power source for an electrical system, according to still another exemplary embodiment.

### DETAILED DESCRIPTION OF THE EXEMPLARY EMBODIMENTS

According to various exemplary embodiments, the standby generator of a building may be used to supplement or replace an off-site utility power source and allow for the consumer to power appliances for a lower cost than the utility power provider. A cost per kWh (e.g., real time cost, cost as a function of time of day, cost as a function of usage, etc) can be provided to the consumer so they know which appliances are more cost effective to operate under standby power rather than prime or utility power. The consumer can decrease energy costs by running electrical loads (e.g., appliances) off of a secondary source of power (e.g., a generator), rather than the primary off-site utility source when it would be more cost effective to do so. This approach puts consumers in more control of the overall cost of electricity.

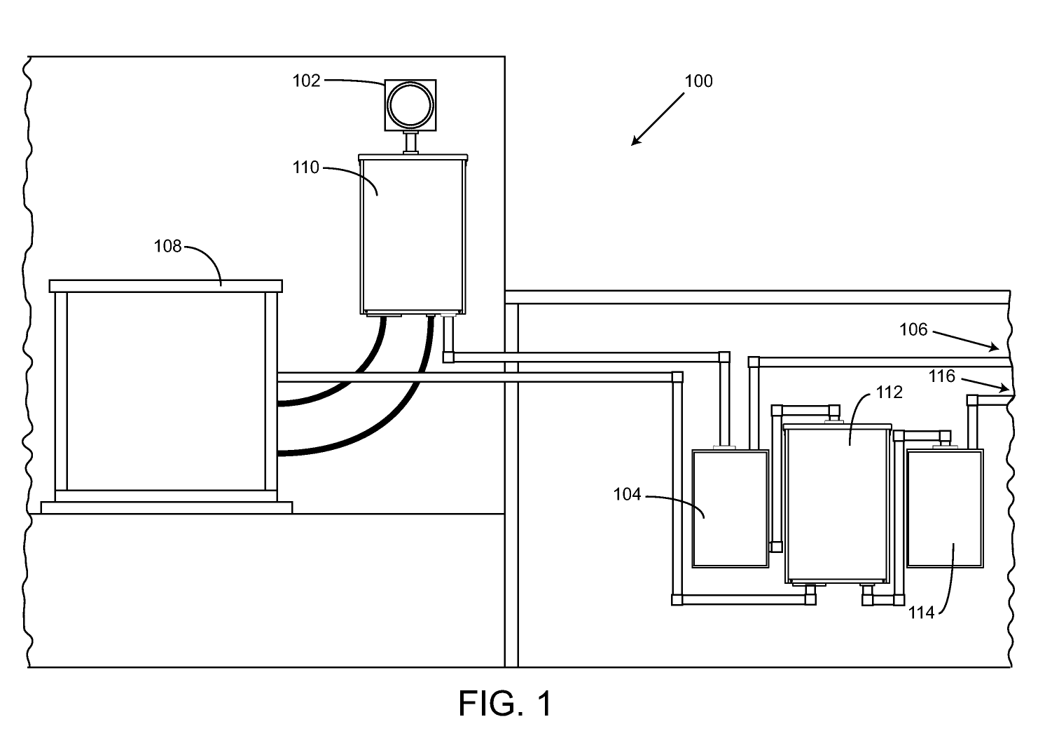

FIG. 1 illustrates an electrical system 100 for a building (e.g., a residential electrical system) according to an exemplary embodiment. Electrical system 100 includes an electric utility meter 102 electrically coupled to an off-site utility power source (not shown) and configured to provide power from the off-site utility source to a distribution panel 104. Distribution panel 104 (e.g., a circuit breaker box, a fuse box, etc.) is configured to route electrical power to electrical loads 106 (not specifically shown in FIG. 1) in the building. Electrical system 100 also includes a generator 108 (e.g. a home standby generator) for providing electrical power to distribution panel 104 instead of or in addition to the power provided at meter 102. Generator 108 may be configured to provide power to distribution panel 104 in the event of a utility power failure. A transfer switch 110 is configured to transfer the source of electrical power provided to distribution panel 104 and may transfer the power source automatically or manually via a user operated lever. For example, in the event of a utility power failure, transfer switch 110 may automatically sense the loss of power and route power from generator 108 to distribution panel 104 instead of from the utility source at meter 102.

Generator 108 and distribution panel 104 are also coupled to a transfer switch 112 (e.g., a cost comparison transfer switch) and a distributional subpanel 114 (e.g., a cost comparison subpanel). Distribution panel 104 may route power for some loads 116 through transfer switch 112 and subpanel 1 14. Transfer switch 112 is configured to determine the most cost effective power source between the generator 108 and the utility source provided via meter 102. If the cost to power loads 116 would be less if the power were provided by generator 108, then transfer switch 112 may route power for loads 116 through subpanel 114 from generator 108 rather than from meter 102. Alternatively, if the cost to power loads 116 would be less if the power were provided from meter 102, then transfer switch 112 may route power for loads 116 from meter 102 rather than from generator 108.

Transfer switch 112 may receive signals representing cost data for comparison purposes from various sources. According to one exemplary embodiment, transfer switch 112 may receive a signal representing utility cost data (e.g., electricity, natural gas for generator 108, etc.) over the utility line using power line carrier (PLC) technology. According to another exemplary embodiments, transfer switch 112 may receive a signal representing utility cost data from a wireless network of the utility, for example a cellular network or wireless transmitters/transceivers installed on meter 102, on power line poles, on power line transformers, on power line crossovers, or on other utility locations. According to still other exemplary embodiments, transfer switch 112 may retrieve a signal representing utility cost data from a computer (e.g., a personal computer) via the Internet, from a database stored in transfer switch 112 or stored in a coupled computer, from an electronic bill, or from user entered data.

Transfer switch 112 may compare the costs of providing power from meter 102 or from generator 108 by calculating a difference in therm ratio. The signals representing cost data received by transfer switch may include the price per therm or price per British thermal unit (BTU) for the power source. Transfer switch 112 may also receive a signal representing data about loads 116 coupled to transfer switch 112 and subpanel 114 (e.g., from a database, from user entry, from loads 116), for example, the therm or BTU usage of the load per kilowatt-hour (kWh). From these signals (e.g., representing cost data and power usage), transfer switch 112 may calculate the price per kWh that loads 116 would use at a particular time for the power source. Thus for any given time period or over preprogrammed time intervals, transfer switch 112 may compare whether it would cost less to provide power to loads 116 from meter 102 or from generator 108. For example, transfer switch 112 may compare costs about every hour, about every 30 minutes, about every ten minutes, about every 5 minutes, about every minute, etc.

For example, a 15 kW generator at half load may use 126,000 BTU/hr of natural gas. The utility company may charge $0.5161 per therm of natural gas in a given month and charge $0.22 per kWh at peak time for electricity. Transfer switch 112 receives a signal representing each of these costs. Given that one therm is about equal to 100,000 BTUs of natural gas, transfer switch 112 determines that a resident running at 7.5 kWh would pay:

$$Gas \text{:} \frac{126 , 000}{100 , 000} = 1.26 therm$$

$$1.26 therm \times \$0 .5161 per kWh = \$0 .6503 per hour for a 7.5 kW load$$

$$Electric \text{:} 7.5 kW \times \$0 .22 per kWh = \$1 .65 per hour for a 7.5 kW load$$

Transfer switch 112 may compare these prices per hour usage to determine a difference of about $1.00 per hour usage of the 7.5 kW load 116 by operating generator 108 with natural gas instead of off-site electric power loads 116. Transfer switch 112 may then operate generator 108 to power load 116 and disconnect power from the off-site source for load 116.

According to various exemplary embodiments, generator 108 may be a home standby generator, a portable generator, or a generator capable of being used by another type of building. According to some exemplary embodiments generator 108 may be powered by natural gas or propane, while according to other exemplary embodiments, generator 108 may be powered by another fuel source such as gasoline. It is noted that while the illustrated exemplary embodiment shows the use of a generator in combination with a utility power source, different configurations are possible. According to some exemplary embodiments, generator 108 may be substituted by a solar, wind, geothermal, or other non-utility or standby power sources. According to other exemplary embodiments, electrical system 100 may include additional standby power sources (e.g., generator, solar, geothermal, etc.) or an additional utility power source that may be used to provide power instead of or in addition to the power provided by generator 108 and meter 102 depending on the cost comparison performed by subpanel 114.

Meter 102, generator 108, and transfer switch 110 are all shown as being mounted exterior of a building (e.g., on the exterior wall or on the ground) while distribution panel 104, transfer switch 112, and subpanel 114 are shown mounted on the interior of the building (e.g., on a basement wall). It is noted that according to other exemplary embodiments, meter 102 and transfer switch 110 may be mounted in the interior of the building or one or more of distribution panel 104, transfer switch 112, and subpanel 114 may be mounted exterior to the building.

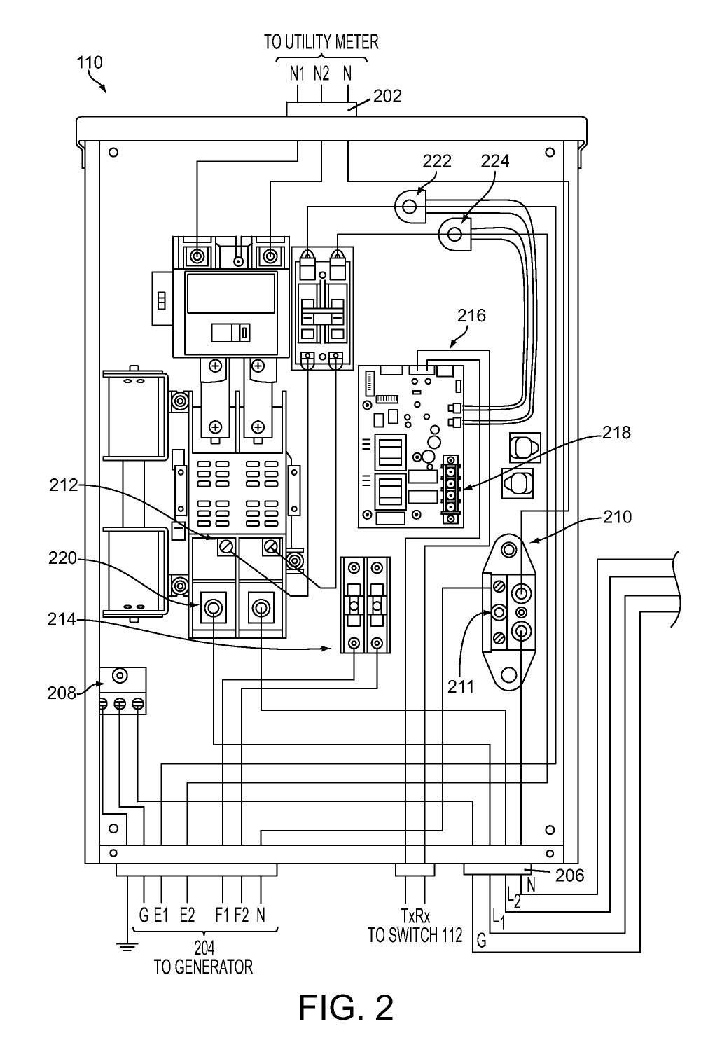

FIG. 2 is a more detailed diagram of transfer switch 110, according to an exemplary embodiment. Transfer switch 110 is coupled to utility meter 102 via a port 202, to generator 108 via a port 204, and to distribution panel 104 via port 206. Transfer switch 110 may be capable of bidirectional communication with utility meter 102, generator 108, and distribution panel 104 via ports 202, 204, and 206, respectively. Transfer switch 110 includes a ground terminal 208 for providing a ground line to generator 108 and distribution panel 104 as well as a neutral terminal 210 secured by a bonding screw 211 for providing a neutral or common line among utility meter 102, distribution panel 104, and generator 108 (line N). Power input lines from generator 108 (lines E1 and E2) are coupled to a generator connection 212, and control lines from generator 108 (lines F1 and F2) are coupled to a generator control connection 214 (e.g., a 240V control connection). A transmit/receive (TxRx) connection 216 couples a controller of transfer switch 112 to a controller 218. According to various exemplary embodiments, controller 218 may be any digital or analog control logic or hardware capable of controlling transfer of power between generator 108 and meter 102 and controlling startup and communication with generator 108. Controller 218 may also be coupled to current transformers 222 and 224, which provide signals to controller 218 representing how much power (kW) generator 108 is supplying. Load lines (L1 and L2) providing power to distribution panel 104 are coupled to transfer switch 110 via a load connection 220.

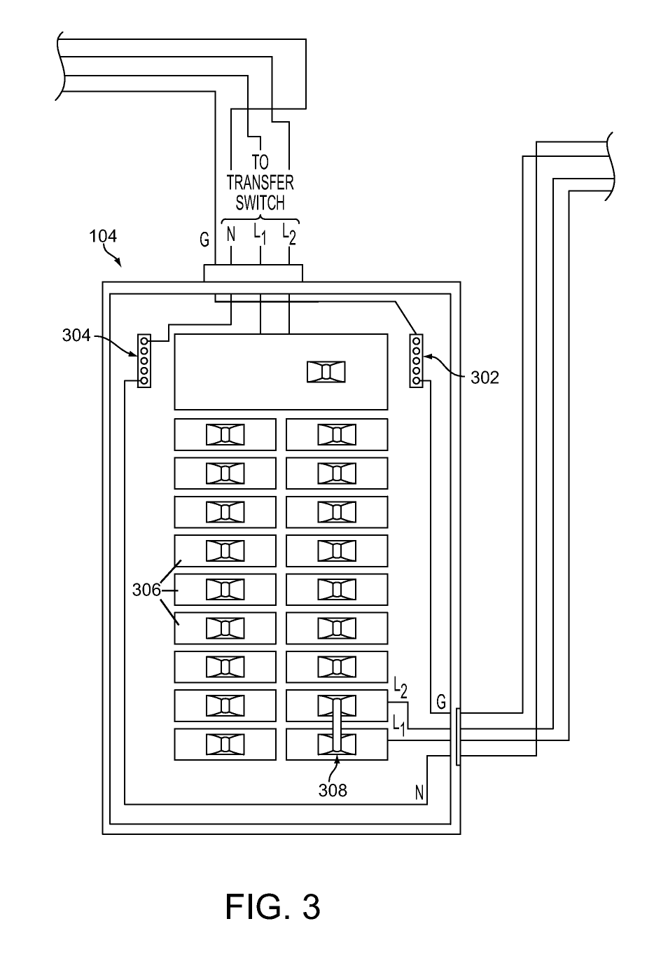

While transfer switch 110 is illustrated as being separate from distribution panel 104, it is noted that according to other exemplary embodiments, transfer switch 110 may be integral with distribution panel 104. Referring also to FIG. 3, a more detailed diagram of distribution panel 104 is illustrated, according to an exemplary embodiment. The ground line (G) from transfer switch 110 is coupled to a ground bus 302 and out to transfer switch 112. The neutral line (N) from transfer switch 110 is coupled to a neutral bus 304 and out to transfer switch 112. Distribution panel 104 includes a number of circuit breakers 306 configured to route power to loads 106 and break the electrical connection to loads 106 in the case of a power surge to reduce damage to the loads. Distribution panel 104 also includes a breaker 308 (e.g., a two pole breaker) configured to route power for loads 116 to transfer switch 112.

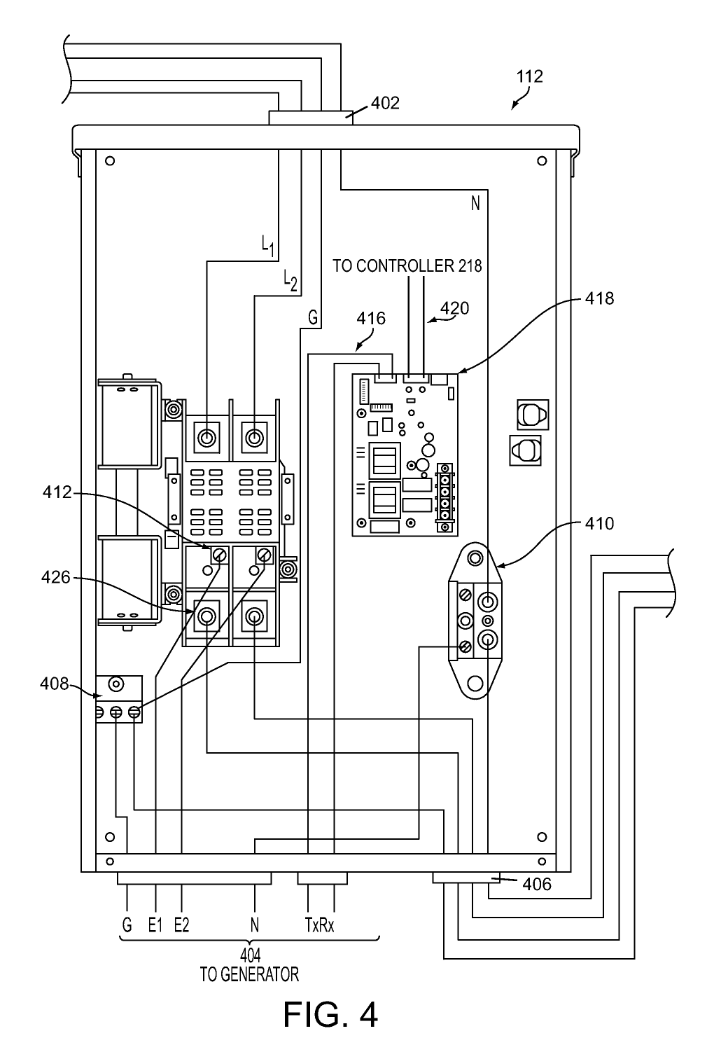

FIG. 4 is a more detailed diagram of transfer switch 112, according to an exemplary embodiment. Transfer switch 112 is coupled to distribution panel 104 via a port 402, to generator 108 via a port 404, and to subpanel 114 via port 406. Transfer switch 112 may be capable of bidirectional communication with distribution panel 104, generator 108, and subpanel 114 via ports 402, 404, and 406, respectively. Transfer switch 112 includes a ground terminal 408 for providing a ground line to generator 108 and subpanel 114 as well as a neutral terminal 410 for providing a neutral or common line among distribution panel 104, subpanel 114, and generator 108 (line N). Power input lines from generator 108 (lines E1 and E2) are coupled to a generator connection 412. A generator communication line 416 (TxRx) is coupled to a control system or a controller 418 (e.g., a cost comparison control board) for bidirectional communication with generator 108 while a communication line 420 facilitates bidirectional communication with controller 218 of transfer switch 110. As such, controller 418 may control operation of controller 218 as well as operation of generator 108.

According to various exemplary embodiments, controller 418 may be any digital or analog control logic or hardware capable of controlling transfer of power between generator 108 and meter 102, capable of controlling startup and communication with generator 108, capable of receive signals representing costs of power sources, and capable of comparing cost and load data to determine whether it would be more cost effective to power loads 116 using generator 108 or using off-site electricity via meter 102. According to some exemplary embodiments, controller 418 could output indicators of cost savings, cost usage of loads 116, and/or power usage of loads 116 to a display, a computer, an email account, a mobile or cellular phone, etc. While controller 418 is illustrated as being mounted in transfer switch 112, according to other exemplary embodiments, controller 418 could mounted at other locations, for example on generator 108, on subpanel 114, on a remotely located computer, etc. Load lines (L1 and L2) providing power to subpanel 114 are coupled to transfer switch 112 via a load connection 426.

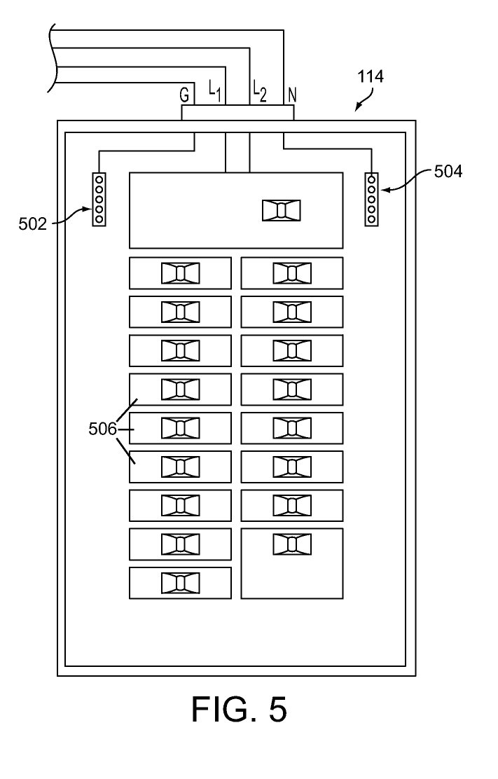

While transfer switch 112 is illustrated as being separate from subpanel 114, it is noted that according to other exemplary embodiments, transfer switch 112 may be integral with subpanel 114. Referring also to FIG. 5, a more detailed diagram of subpanel 114 is illustrated, according to an exemplary embodiment. The ground line (G) from transfer switch 112 is coupled to a ground bus 502 while the neutral line (N) from transfer switch 112 is coupled to a neutral bus 504. Subpanel 114 includes a number of circuit breakers 506 configured to route power to loads 116 and break the electrical connection to loads 116 under certain circumstances (e.g., a power surge) to reduce damage to the loads and protect electrical circuits. While a specific number of breakers and loads are illustrated in the figure, according to other exemplary embodiments, varying numbers of loads may be coupled to subpanel 114, for example four large loads or loads that are specifically selected. The loads that are coupled to subpanel 114 may be selected based on a variety of criteria. For example, it may be beneficial to couple appliances that run during “peak” utility source times of day to transfer switch 112 to run more cost effectively (e.g., an air conditioner, a refrigerator, a tank water heater, etc.). In another example, it may be beneficial to couple appliances that run more frequently to transfer switch 112 to optimize usage of the cost comparisons made by transfer switch 112 (e.g., a water heater, a furnace, a refrigerator, etc.).

It is noted that while FIGS. 2-5 are schematic diagrams showing certain wire routing and specific components according to one exemplary embodiment, according to other exemplary embodiments, the transfer switches and distribution panels of FIGS. 2-5 may include various other configurations, components, and wire routing to support the power transfer and cost comparison functionality described herein.

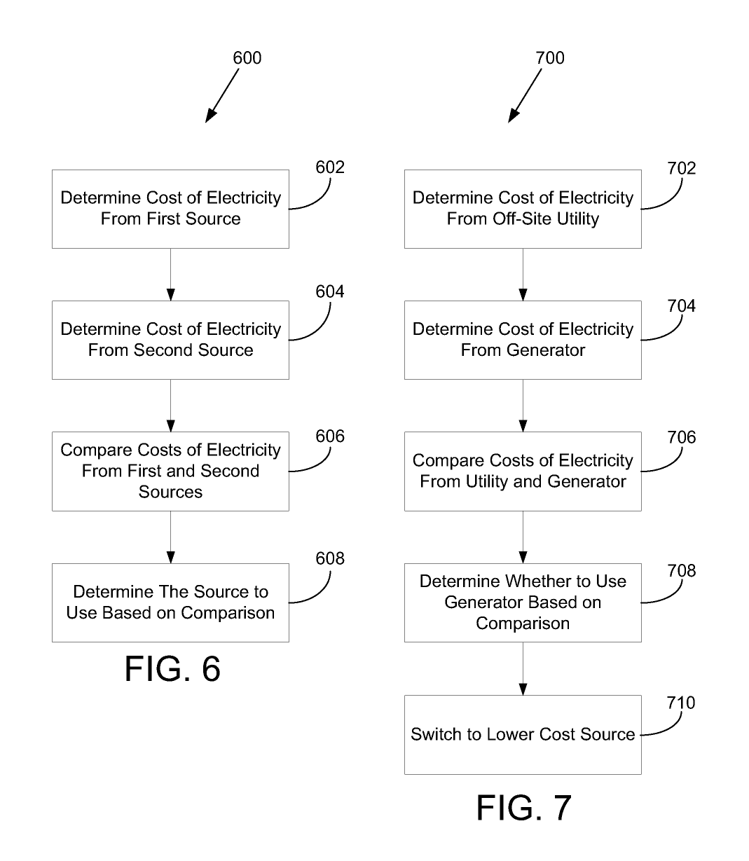

Referring to FIG. 6, a flow chart illustrates a method 600 for selecting a power or electricity source for an electrical system (e.g., a residential electrical system), according to an exemplary embodiment. Transfer switch 112 (e.g., controller 418) determines a cost of electricity or power from a first source (step 602). Transfer switch 112 then determines a cost of electricity or power from a second source (step 604). Transfer switch 112 compares the costs of electricity or power from the first and second sources (step 606). Transfer switch 112 also determines the power source to use based on the comparison made (step 608). Thereafter transfer switch 112 can switch to the appropriate power source or remain on the current power source based on the determination, including operating or shutting down generator 108.

Referring to FIG. 7, a flow chart illustrates a method 700 for selecting a power or electricity source for an electrical system (e.g., a residential electrical system), according to another exemplary embodiment. Transfer switch 112 (e.g., controller 418) determines a cost of electricity or power from an off-site utility source at meter 102 (step 702). Transfer switch 112 also determines a cost of electricity or power from standby generator 108 (step 704). Transfer switch 112 compares the costs of electricity or power from meter 102 and generator 108 (step 706). Transfer switch 112 then determines the power source to use based on the comparison made (step 708). Thereafter transfer switch 112 can switch to the appropriate power source or remain on the current power source based on the determination (step 710), including operating or shutting down generator 108.

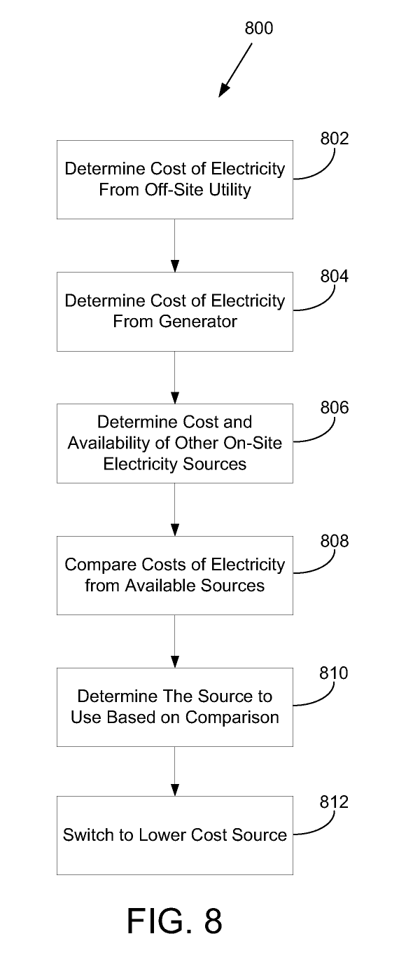

Referring to FIG. 8, a flow chart illustrates a method 800 for selecting a power or electricity source for an electrical system (e.g., a residential electrical system), according to another exemplary embodiment. Transfer switch 112 (e.g., controller 418) determines a cost of electricity or power from an off-site utility source at meter 102 (step 802). Transfer switch 112 also determines a cost of electricity or power from standby generator 108 (step 804). Transfer switch 112 also determines a cost and availability of electricity or power from other on-site electrical sources, for example cost and availability of solar (e.g., sufficient sun or stored power available), wind (e.g., enough wind available), or geothermal sources. (step 806). Transfer switch 112 compares the costs of available electricity or power from meter 102 and generator 108 and possibly from other on-site sources if power is available (step 808). Transfer switch 112 then determines the power source to use based on the comparison made (step 810). Thereafter transfer switch 112 can switch to a different power source or remain on the current power source based on the determination (step 812), including operating or shutting down generator 108.

While the exemplary embodiments illustrated in the figures and described herein are presently preferred, it should be understood that these embodiments are offered by way of example only. Accordingly, the present application is not limited to a particular embodiment, but extends to various modifications. The order or sequence of any processes or method steps may be varied or re-sequenced according to alternative embodiments.

The present application contemplates methods, systems and program products on any machine-readable media for accomplishing its operations. The embodiments of the present application may be implemented using existing computer processors or logic controllers, or by a special purpose computer processor or logic controller for an appropriate system, incorporated for this or another purpose or by a hardwired system.

It is important to note that the construction and arrangement of the control system and home electricity system shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter. For example, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A control system for a home generator, comprising:
circuitry configured to:
determine a first cost of electricity provided by an off-site provider;
determine a second cost of electricity produced by the home generator;
compare the first cost with the second cost; and
provide a result of the comparison as an output.

2. The control system of claim 1, wherein the circuitry is configured to determine the first cost by receiving a signal representing a cost of electricity from the off-site provider.

3. The control system of claim 2, wherein the signal represents a real time cost of electricity or is received from a database of values provided by the off-site provider based on a time of day.

4. The control system of claim 1, wherein the circuitry is configured to determine the second cost by receiving a signal representing a cost of fuel for the home generator and by determining a cost of electricity provided by the home generator based on the received signal.

5. The control system of claim 1, wherein the circuitry is further configured to operate or shut down the home generator based upon the result of the comparison.

6. The control system of claim 5, wherein the circuitry is configured to operate the home generator when the second cost of electricity is less than the first cost of electricity and is configured to shut down the home generator when the second cost of electricity is greater than the first cost of electricity.

7. The control system of claim 1, wherein the circuitry is configured to perform the determination of the first cost, the determination of the second cost, and the comparison at preprogrammed time intervals.

8. The control system of claim 1, wherein the home generator is a home standby generator.

9. A method of controlling a home generator, comprising:
determining a first cost of electricity provided by an off-site provider;
determining a second cost of electricity produced on-site;
comparing the first cost of electricity to the second cost of electricity; and
using a result of the comparison to decide whether to operate the home generator to produce electricity instead of using the electricity provided by the off-site provider.

10. The method of claim 9, wherein the determining the first cost comprises receiving a signal representing a cost of electricity from the off-site provider.

11. The method of claim 10, wherein the signal represents a real time cost of electricity or is received from a database of values provided by the off-site provider based on a time of day.

12. The method of claim 9, wherein the determining the second cost comprises receiving a signal representing a cost of fuel for the home generator and determining a cost of electricity provided by the home generator based on the received signal.

13. The method of claim 9, wherein the determining the first cost, the determining the second cost, and the comparing are performed at preprogrammed time intervals.

14. The method of claim 9, further comprising operating the home generator when the first cost of electricity is greater than the second cost of electricity and shutting down the home generator when the second cost of electricity is greater than the first cost of electricity.

15. A home electricity system, comprising:
a circuit breaker panel coupled to a number of electrical loads;
a transfer switch coupled to the circuit breaker panel;
a power line coupled to the transfer switch and configured to provide electricity from a utility provider;
an engine-generator-set coupled to the transfer switch; and
a control system configured to:
determine a first cost of electricity provided by the utility provider;
determine a second cost of electricity produced on-site; and
compare the first cost with the second cost and provide a result of the comparison as an output.

16. The home electricity system of claim 15, wherein the control system is configured to determine the first cost by receiving a signal representing a real time cost of electricity from the utility provider or by receiving a signal from a database of values provided by the utility provider based on a time of day.

17. The home electricity system of claim 15, wherein the control system is configured to determine the second cost by receiving a signal representing a cost of fuel for the engine-generator-set and by determining a cost of electricity provided by the engine-generator-set based on the received signal.

18. The home electricity system of claim 15, wherein the control system is configured to operate the engine-generator-set when the second cost of electricity is less than the first cost of electricity and is configured to shut down the engine-generator-set when the second cost of electricity is greater than the first cost of electricity.

19. The home electricity system of claim 15, wherein the control system is configured to perform the determination of the first cost, the determination of the second cost, and the comparison at preprogrammed time intervals.

20. The home electricity system of claim 15, wherein the engine-generator-set is a home standby generator.
